(19) United States
(12) Patent Application Publication
(10) Pub. No.: US 2017/0336184 A1
(43) Pub. Date: Nov. 23, 2017

(54) SPLIT CHORD DEPLOYABLE WING

(71) Applicant: Raytheon Company, Waltham, MA (US)

(72) Inventor: Paul A. Merems, Tucson, AZ (US)

(21) Appl. No.: 15/161,261

(22) Filed: May 22, 2016

(51) Int. Cl. F42B 10/14; F42B 15/01; B64C 3/56; B64C 39/02

(52) U.S. Cl. CPC F42B 10/14; B64C 39/024; F42B 15/01; B64C 3/56; B64C 2201/021; B64C 2201/102; B64C 2201/08

(57) ABSTRACT

A split-chord deployable wing for aerial vehicles such as missiles, UAVs, MALDs and SDBs that require both longer wing span and increased chord length. Such split-chord deployable wings must address unique problems such as synchronized deployment and integrity of the deployed wing to both vertical and sheer loads. Each wing comprises a pair of wing sections stowed fore and aft along the fuselage. Complementary gear teeth synchronize deployment of the wing sections. A deployment mechanism synchronizes deployment of the wings. Complementary tongue and groove surface portions of the wing sections progressive engage as the wing sections pivot away from the fuselage. The surface portions are segmented so that tongue segments are nested within complementary groove segments to provide both vertical and sheer stability.

### BACKGROUND OF THE INVENTION

### Field of the Invention

This invention relates to deployable wings for missiles, unmanned aerial vehicles (UAVs), miniature air launched decoys (MALDs), small diameter bombs (SDBs) and the like.

### Description of the Related Art

Container or tube launched aerial vehicles such as missiles, UAVs, MALDS, SDBs require the wings to be in a stowed position along or inside the fuselage and to transition to a deployed position upon launch. The pair of wings may be stowed along the center-line of the vehicle either against or recessed within the fuselage or may be stowed on top of the vehicle. A deployment mechanisms such as springs, gas springs, and motors to deploy the wings. In most cases these systems are configured to deploy the wings in sync. The wing's chord length is limited by the space constraints and ability to stow the wings. There are many instances of deployable wings to provide wingspan and chord length. However, these wings lack the rigidity of a unitary wing required of many aerial vehicles and missions.

U.S. Pat. No. 4,440,360 entitled “Extendable Fin” discloses a projectile or the like which is fin-stabilized (spinning), an extendable fin is utilized which is intended to be retracted to within the body of the shell during firing in a barrel or the like and to be extended as soon as the shell or the like has left the barrel. The extendable fin is intended to increase the stability of the ammunition unit in the ballistic trajectory. The extendable fin consists of two fin parts supported separately in relation to each other and which in their extended positions are joined together and form the fin. Each extendable fin is independently deployed in response to rotational acceleration of the projectile which forces the fin parts to pivot. In an embodiment gear arcs are arranged at the rear edges of the fin parts, and are located at the upper, rear corners of the fin parts. When the first fin part is extended, the teeth on the two fin parts go into coaction with each other, and a coordinated extending function for the fin parts is obtained.

As disclosed at col. 4, lines 10-14 of U.S. Pat. No. 4,440,360 “The fin parts thus extended form a configuration above the upper edge 3a of the main fin which is effective for the stabilization of the shell. The wide (2 times the width of the respective fin part, i.e. twice as wide as previously) and the comparatively short fin is entirely superior to the fin configuration above the edge 2a which is obtained with the spring fin 5 (FIG. 1). It has been proved that a greater degree of extension for the fin 5 than shown in FIG. 1 gives only an insignificant increase of the stability of the shell, and it has therefore not been possible to use this way of increasing the stability.” The fins are typically 2-3 inches in length to provide stabilization for these spinning projectiles.

### SUMMARY OF THE INVENTION

The following is a summary of the invention in order to provide a basic understanding of some aspects of the invention. This summary is not intended to identify key or critical elements of the invention or to delineate the scope of the invention. Its sole purpose is to present some concepts of the invention in a simplified form as a prelude to the more detailed description and the defining claims that are presented later.

The present invention provides a split-chord deployable wing for aerial vehicles such as missiles, UAVs, MALDs and SDBs that require both longer wing span and increased chord length. Such split-chord deployable wings must address unique problems such as synchronized deployment and integrity of the deployed wing to both vertical and sheer loads. In most instances, the size of the wing and limited fuselage volume dictates that the wing must be stowed outside the vehicle fuselage.

In an embodiment, a split chord deployable wing air vehicle comprises a pair of deployable wings on opposite sides of the fuselage. Each wing comprises first and second longitudinally extending planar wing sections stowed along the fuselage, which have abutting ends and first and second exterior longitudinal edges in a common plane. Each wing section is mounted for rotation in the common plane on separate pivot points adjacent the abutting ends. The remaining free ends of the first and second wing sections extend in opposite directions fore and aft from the pivot points. The first and second wing sections have complementary tongue and groove surface portions formed along the first and second exterior longitudinal edges that are progressively engaged as the first and second wing sections pivot away from said fuselage to form a single interlocked wing. Complementary gear teeth are formed at the abutting ends of the first and second wing sections for each of the pair of deployable wings. The complementary gear teeth synchronize movement of the first and second wing sections in the common plane. A deployment mechanism is configured to drive the complementary gear teeth for synchronized deployment of the pair of deployable wings.

In an embodiment, the first and second wing sections' complementary tongue and groove surface portions are segmented so that tongue segments are nested within complementary groove segments. The tongue segments are surrounded on four sides, above and below and interior and exterior, by the groove segments to interlock and form the single interlocked wing to provide both vertical stability at an interface between the first and second wing sections to loads normal to the wing and sheer stability axially along the interface.

In an embodiment, the first and second wing sections include a locking mechanism at the remaining free ends that hold the interlocked wing in place once deployed.

In different embodiments, the first and second wing sections are at least 1 foot in length or at least 3 feet in length.

In an embodiment, the deployment mechanism comprises a sync gear that engages the teeth on one of the first or second wing sections for each of the pair of deployable wings to synchronize deployment of the pair of deployable wings. The sync gear may be driven by centripetal force, a spring or a motor for example.

In an embodiment for a tube-launched missile, a split chord deployable wing assembly is connected between a rocket motor assembly aft and a guidance and warhead assembly forward. This assembly may be used to retrofit existing missiles or with new missile designs. Alternately, the wing sections and deployment mechanisms may be integrated into new missile designs.

In an embodiment for a tube-launched missile, the missile comprises a plurality of dorsal fins positioned about the circumference of the missile fuselage and running parallel to the longitudinal axis. In the stowed positioned, the first and second wing sections may be offset from the dorsal fins, form part of two of the dorsal fins or all of two of the dorsal fins.

These and other features and advantages of the invention will be apparent to those skilled in the art from the following detailed description of preferred embodiments, taken together with the accompanying drawings, in which:

### BRIEF DESCRIPTION OF THE DRAWINGS

FIGS. 1a-1d are diagrams of a split chord deployable wing missile in the stowed perspective and in tube, transition and deployed positions, respectively;

FIGS. 2a-2b are diagrams of the split chord deployable wing assembly for a tube-launched missile in stowed and deployed positions, respectively;

FIGS. 3a-3b are different views of a deployment mechanism for simultaneous deployment of the forward and aft wing sections for the pair of wings;

FIGS. 4a and 4c are different views of a segmented tongue and groove mechanism for progressively locking the forward and aft wing elements as they deploy;

FIGS. 5a and 5b are different views showing the progressive engagement of the segmented tongue and groove sections to form an interlocked wing;

FIGS. 6a ad 6b are different views of a wing locking mechanism; and

FIG. 7 is a perspective view of a UAV with a split chord deployable wing.

### DETAILED DESCRIPTION OF THE INVENTION

The present invention describes a split-chord deployable wing for aerial vehicles such as missiles, UAVs, MALDs and SDBs that require both longer wing span and increased chord length. Such split-chord deployable wings must address unique problems such as synchronized deployment and integrity of the deployed wing to both vertical and sheer loads. Each wing comprises a pair of wing sections stowed fore and aft along the fuselage. Complementary gear teeth synchronize deployment of the wing sections. A deployment mechanism synchronizes deployment of the wings. Complementary tongue and groove surface portions of the wing sections progressive engage as the wing sections pivot away from the fuselage. The surface portions are segmented so that tongue segments are nested within complementary groove segments to provide both vertical and sheer stability.

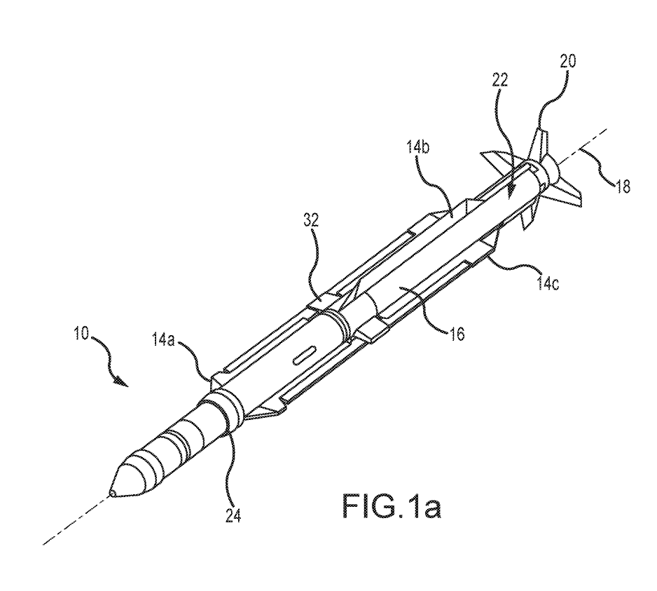

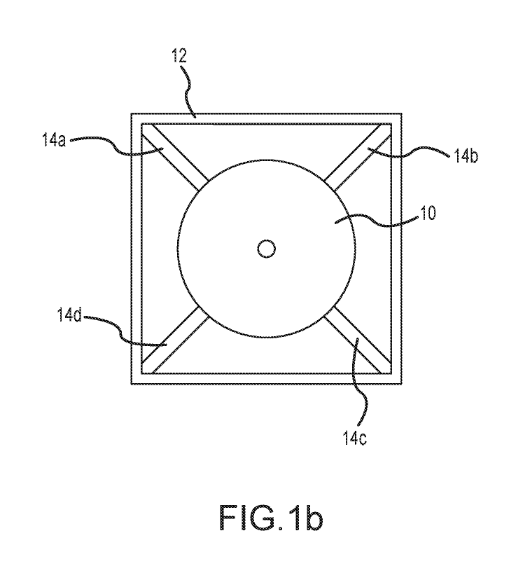

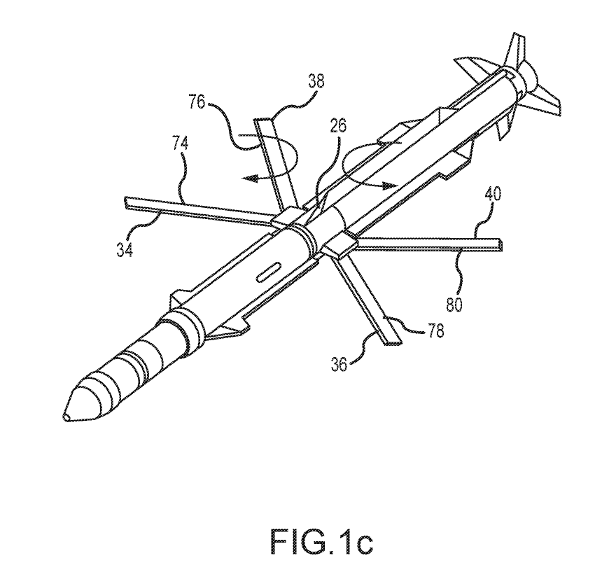

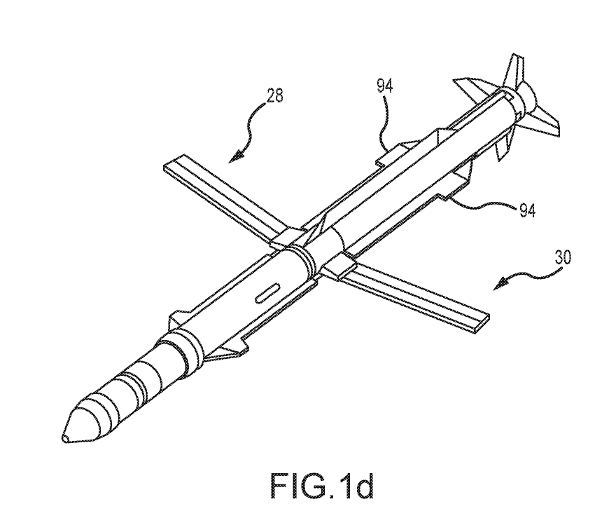

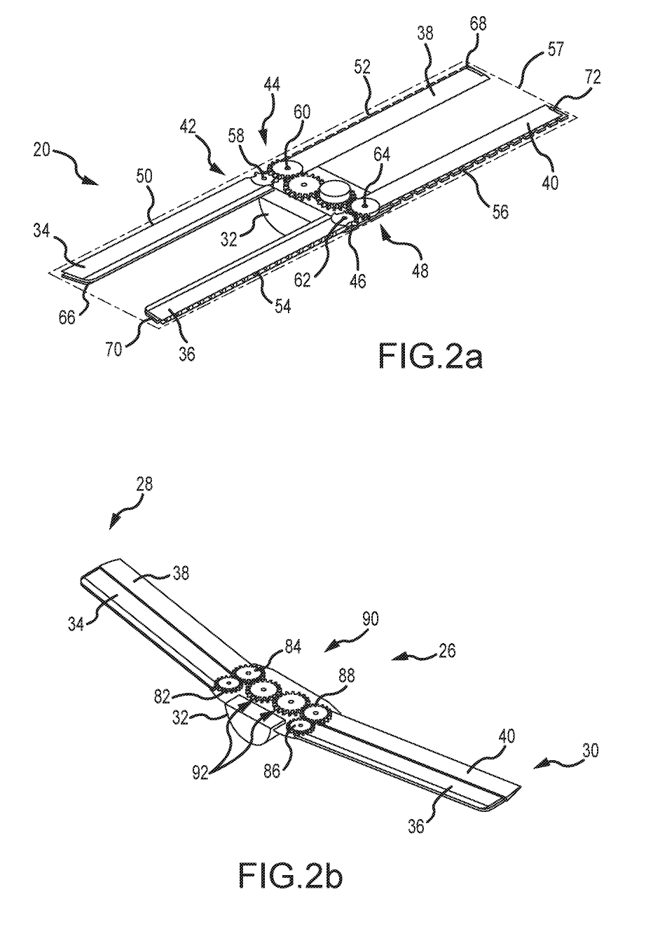

Referring now to FIGS. 1a-1d and 2a-2b, an embodiment of a tube-launched missile includes a missile 10 initially stowed inside a launch tube 12. Four dorsal fins 14a, 14b, 14c and 14d are positioned at 90° intervals about the circumference of a missile fuselage 16 and running parallel to a longitudinal axis 18. Dorsal fins have very limited span, a few inches. The dorsal fins are sufficient to provide lift for short flights. Greater wingspan and surface area is required for longer flights. Fins 20 are positioned at the tail of the missile for stability.

Missile 10 includes a rocket motor assembly 22 aft and a guidance and warhead assembly 24 forward. A split chord deployable wing assembly 26 is connected between the rocket motor assembly and the warhead assembly to provide a pair of deployable wings to provide the lift efficiency for longer flights. The assembly 26 is retrofit compatible with both the missile 10 and the launch tube 12. The assembly 26 may also be configured for use with new missile and launch tube designs.

Split chord deployable wing assembly 26 includes a pair of deployable wings 28, 30 on opposite sides of a fuselage section 32. Each wing 28, 30 comprising first 34, 36 and second 38, 40 longitudinally extending planar wing sections stowed fore and aft along the fuselage 16. The first and second wing sections have abutting ends 42, 44 and 46, 48 and first and second exterior longitudinal edges 50, 52 and 54, 56 in a common plane 57 for the pair of wings. Each wing section is mounted for rotation in the common plane 57 on separate pivot points 58, 60 and 62, 64 adjacent the abutting ends. The remaining free ends 66, 68 and 70, 72 of the first and second wing sections extend in opposite directions fore and aft from the pivot points. The first and second wing sections have complementary tongue and groove surface portions 74, 76 and 78, 80 formed along the first and second exterior longitudinal edges that are progressively engaged as the first and second wing sections pivot away from the fuselage to form the single interlocked wing 28, 30. Complementary gear teeth 82, 84 and 86, 88 are formed at the abutting ends of the first and second wing sections for each of the pair of deployable wings 28, 30. The complementary gear teeth synchronize movement of the first and second wing sections in the common plane. A deployment mechanism 90 is configured to drive the complementary gear teeth for synchronized deployment of the pair of deployable wings. In this embodiment, deployment mechanism 90 includes a sync gear(s) 92 that synchronizes movement of the left and right wings 28, 30. The gear teeth of sync gear(s) 92 engage the gear teeth on one of the first and second wing sections for each wing. The centripetal force provided at launch is used to drive deployment. In this embodiment, each wing section has a span of approximately 5 feet and a chord length of 6″ for a deployed chord length of 12″. The wing sections are geared to provide a 10-degree backward sweep for the wing.

The first and second wing sections may or may not each be one-half the total chord length. The aerodynamics of the wing may suggest cutting the wing at its mid-point or at an offset to the mid-point. The cross-sections of the first and second wing sections are not typically the same. The first wing section forms the forward portion of the wing and the second wing section forms the aft portion of the wing. The first and second wing sections may or may not have a constant chord length along the span of the wing.

For the tube-launched missile, the first and second wing sections in their stowed positions may be offset from the dorsal fins (above or below the fuselage) or may be positioned mid-fuselage to form an exterior portion of two of the dorsal fins 14a and 14c (as depicted in the drawings) or form the entirety of two of the dorsal fins. As depicted, two of the dorsal fins 14b and 14d are fixed and two of the dorsal fins 14a and 14c have fixed interior portions 94 and an interior portioned formed by the stowed wing sections. The dorsal fins would ordinarily be used to provide lift/stability until the wings were deployed. Therefore using the stowed wings to provide the dorsal fins until deployment of the wings is feasible.

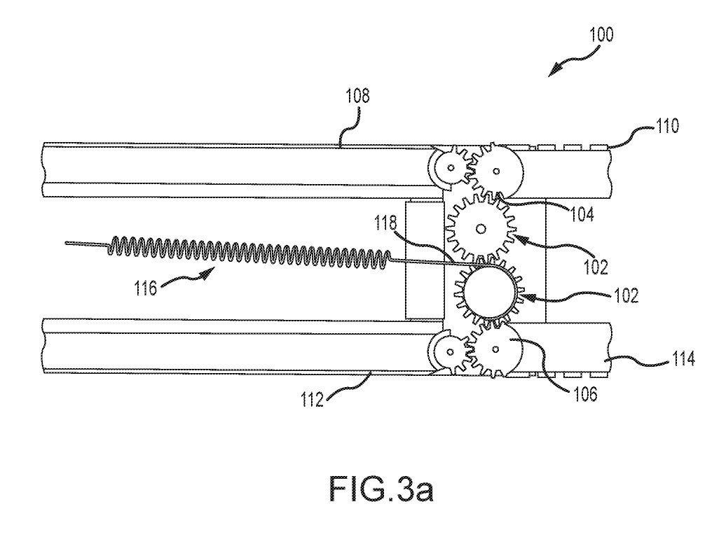

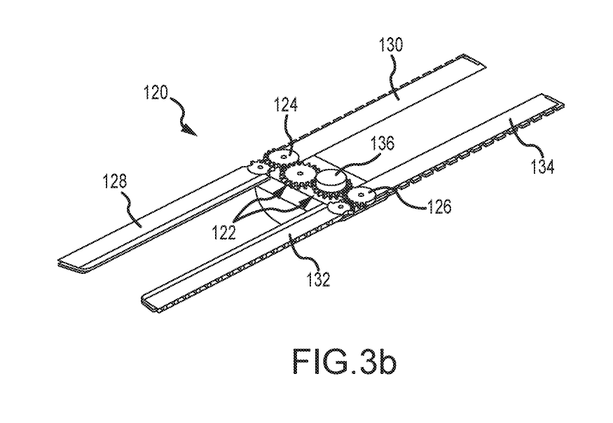

Referring now to FIGS. 3a and 3b, a deployment mechanism 100 includes a sync gear 102 configured to engage the gear teeth 104, 106 on one of the first and second wing sections 108, 110 and 112, 114 for each wing. A tensioned spring 116 is attached to a cable 118 that is wrapped around sync gear 102. At launch, or upon command a spring 116 is released and pulls cable 118 to actuate sync gear 102, which simultaneously engages the gear teeth on one of the first and second wing sections for each wing to simultaneously deploy the wing sections. Alternately, the sync gear can be omitted and a pair of springs and cables used to directly actuate each pair of wing sections. The springs are released in sync to synchronize the deployment. Another deployment mechanism 120 includes a sync gear 122 configured to engage the gear teeth 124, 126 on one of the first and second wing sections 128, 130 and 132, 134 for each wing. A motor 136 is directly coupled to the sync gear 122 to drive the sync gear to deploy the wing sections.

As compared with “fins” used to stabilized spinning projectiles, “wings” used to provide lift for aerial vehicles such as missiles, UAVs, MALDs and SDBs that require both longer wing span and increased chord length. The wings may be formed to include aerodynamic controls surfaces, ones that are controllable to affect lift and maneuverability. The integrity of the deployed wing to both vertical and sheer loads is critical.

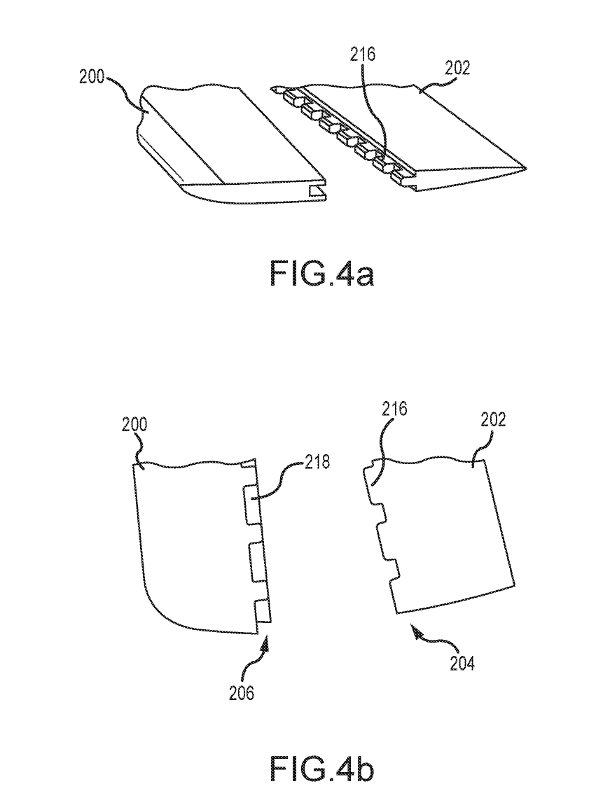

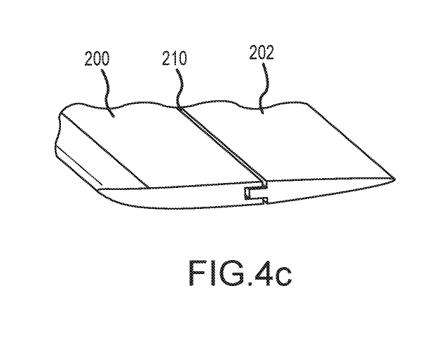

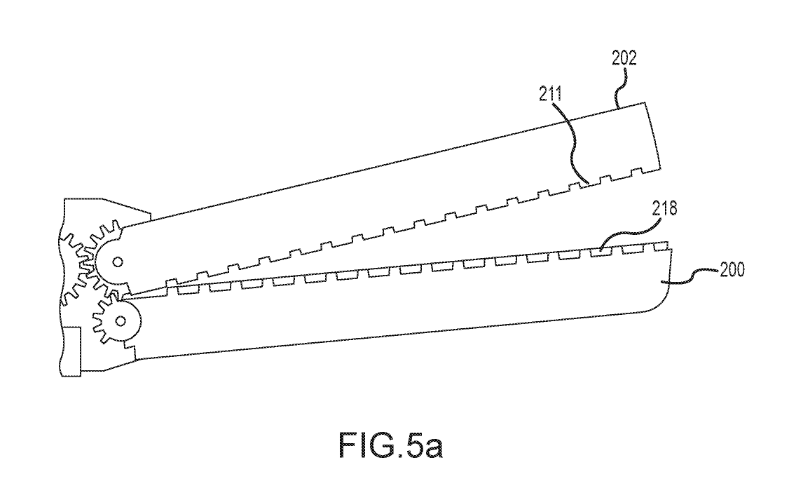

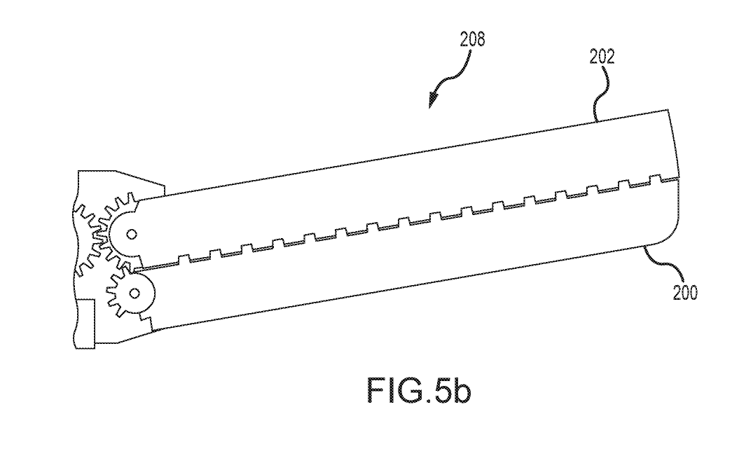

Referring now to FIGS. 4a-4c and 5a-5b, in an embodiment, first and second wing sections 200 and 202 are formed with complementary tongue and groove surface portions 204 and 206 formed along the first and second exterior longitudinal edges that are progressively engaged as the first and second wing sections 200 and 202 pivot away from said fuselage to form a single interlocked wing 208. The tongue and groove surface portions can be formed on the forward and aft wing sections or vice-versa.

A single contiguous tongue and groove mechanism provides vertical stability at an interface 210 between the wing sections to loads normal to the wing but does not provide sheer stability axially along interface 210. Both are critical.

In a preferred embodiment, the tongue and groove surface portions 204 and 206 are segmented so that individual tongue segments 216 are nested within complementary groove segments 218. The tongue segments 216 are surrounded on four sides, above and below and interior and exterior, by the groove segments 218 to interlock and form the single interlocked wing to provide both vertical stability at the interface 210 between the first and second wing sections to loads normal to the wing and sheer stability axially along the interface 210. The segmented tongue and groove in essence forms a two-dimensional zipper, providing the vertical stability of the basic tongue and groove structure and the sheer stability of the segmented structure.

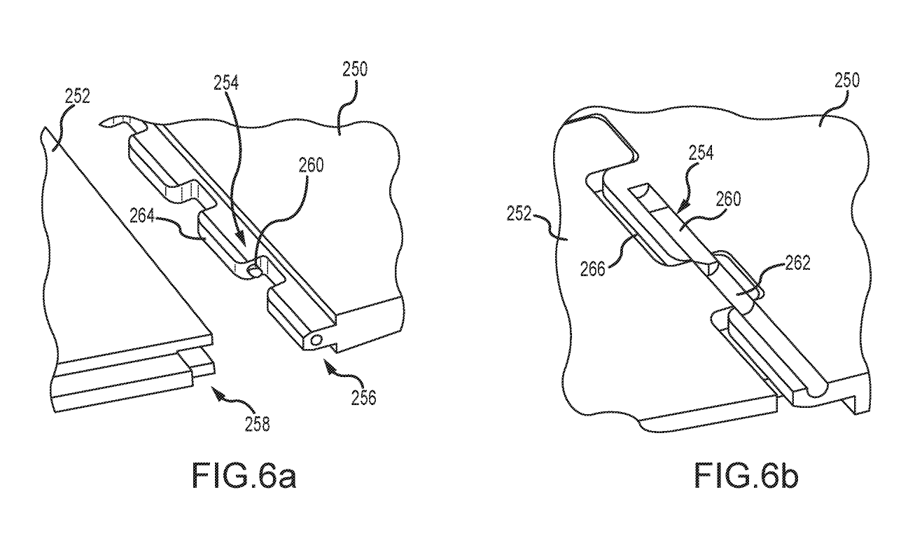

Referring now to FIGS. 6a-6b, in an embodiment, first and second wing sections 250, 252 include a locking mechanism 254 formed in the segmented tongue and groove surface portions 256, 258 towards the remaining free ends that hold the interlocked wing in place once deployed. In this example, locking mechanism 254 includes a spring loaded pin 260 formed in the segmented tongue surface portion 256 and a channel 262 formed in the tongue and groove surface portions 256, 258. When the tongue segment 264 engages a corresponding groove segment 266, the spring-loaded pin 260 deploys into channel 262 spanning both the tongue and groove segments to hold the interlocked wing in place.

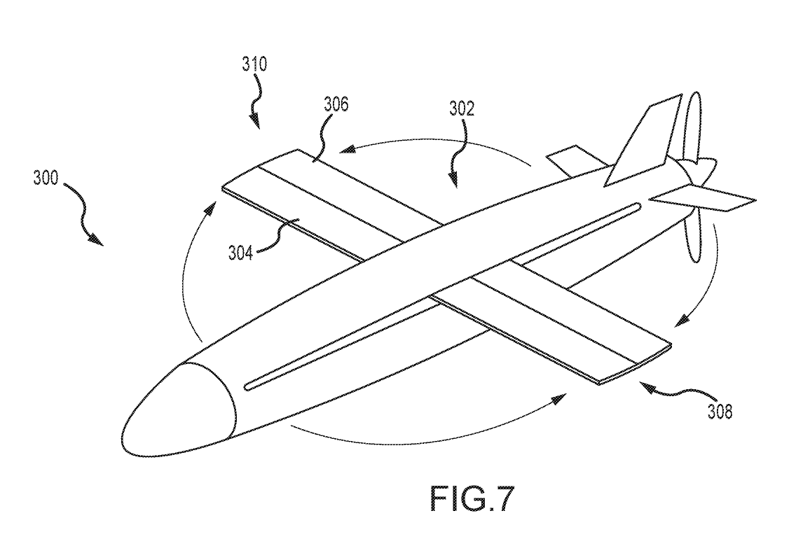

Referring now to FIG. 7, a UAV 300 includes a split chord deployable wing assembly 302 in which fore and aft wing sections 304 and 306 are stored against, or recessed partially or entirely within, a fuselage. The UAV is typically stowed in and deployed from a container, hence the need for deployable wings. The fore and aft wing sections 304 and 306 have complementary gear teeth that synchronize their deployment and set any wing sweep. A deployment mechanism of the type previously described provides for synchronized deployment of the left and right wings 308 and 310. The wing sections are suitably formed with the segmented tongue and groove structures to form the interlocked wing. The wing sections, gears and deployment mechanisms are suitably integrated into the overall UAV design. Each wing has a span of at least 1 foot or at least 3 feet for different UAVs.

While several illustrative embodiments of the invention have been shown and described, numerous variations and alternate embodiments will occur to those skilled in the art. Such variations and alternate embodiments are contemplated, and can be made without departing from the spirit and scope of the invention as defined in the appended claims.

I claim:

1. A split chord deployable wing air vehicle, comprising:
a fuselage having a longitudinal axis;
a pair of deployable wings on opposite sides of the fuselage, each wing comprising first and second longitudinally extending planar wing sections stowed along the fuselage, which have abutting ends and first and second exterior longitudinal edges in a common plane, each wing section mounted for rotation in the common plane on separate pivot points adjacent said abutting ends, remaining free ends of said first and second wing sections extending in opposite directions fore and aft from said pivot points, said first and second wing sections having complementary tongue and groove surface portions formed along the first and second exterior longitudinal edges that are progressively engaged as the first and second wing sections pivot away from said fuselage to form a single interlocked wing;
complementary gear teeth at the abutting ends of the first and second wing sections for each of the pair of deployable wings, said complementary gear teeth synchronizing movement of the first and second wing sections in the common plane; and
a deployment mechanism configured to drive the complementary gear teeth for synchronized deployment of the pair of deployable wings.

2. The split chord deployable wing air vehicle of claim 1, wherein said first and second wing sections' complementary tongue and groove surface portions are segmented so that tongue segments are nested within complementary groove segments, said tongue segments surrounded on four sides, above and below and interior and exterior, by the groove segments to interlock and form the single interlocked wing to provide both vertical stability at an interface between the first and second wing sections to loads normal to the wing and sheer stability axially along the interface.

3. The split chord deployable wing air vehicle of claim 1, wherein at least one of said first and second wing sections comprise a locking mechanism at the remaining free end of the wing section that engages the other wing section to lock the single interlocked wing in place once deployed.

4. The split chord deployable wing air vehicle of claim 1, where each of said first and second wing sections is at least 1 foot in length.

5. The split chord deployable wing air vehicle of claim 1, where each of said first and second wing sections is at least 3 feet in length.

6. The split chord deployable wing air vehicle of claim 1, wherein the deployment mechanism comprises a sync gear that engages the teeth on one of the first or second wing sections for each of the pair of deployable wings to synchronize deployment of the pair of deployable wings.

7. The split chord deployable wing air vehicle of claim 1, wherein the wings are synchronously deployed in response to centripetal force.

8. The split chord deployable wing air vehicle of claim 1, wherein the deployment mechanism further comprises a spring or motor to drive the sync gear to synchronously deploy the pair of wings.

9. The split chord deployable wing air vehicle of claim 1, wherein the aerial vehicle if a self-propelled missile or rocket, a miniature air launched decoy (MALD), a small diameter bomb (SDB), an unmanned aerial vehicle (UAV) or a micro aerial vehicle (MAV).

10. The split chord deployable wing air vehicle of claim 1, wherein the first and second longitudinally extending planar wing sections are stowed along and outside of the fuselage.

11. A split chord deployable wing unmanned aerial vehicle (UAV), comprising:
a UAV fuselage having a longitudinal axis;
a pair of deployable wings on opposite sides of the UAV fuselage, each wing comprising first and second longitudinally extending planar wing sections stowed along the fuselage, which have abutting ends and first and second exterior longitudinal edges in a common plane, each wing section mounted for rotation in the common plane on separate pivot points adjacent said abutting ends, remaining free ends of said wing sections extending in opposite directions fore and aft from said pivot points, said first and second wing sections having complementary tongue and groove surface portions formed along the first and second exterior longitudinal edges that are progressively engaged as the first and second wing sections pivot away from said fuselage to form a single interlocked wing;
complementary gear teeth at the abutting ends of the first and second wing sections for each of the pair of deployable wings, said complementary gear teeth synchronizing movement of the first and second wing sections in the common plane; and
a deployment mechanism configured to drive the complementary gear teeth for synchronized deployment of the pair of deployable wings.

12. The split chord deployable wing UAV of claim 11, wherein said first and second wing sections' complementary tongue and groove surface portions are segmented so that tongue segments are nested within complementary groove segments, said tongue segments surrounded on four sides, above and below and interior and exterior, by the groove segments to interlock and form the single interlocked wing to provide both vertical stability at an interface between the first and second wing sections to loads normal to the wing and sheer stability axially along the interface.

13. The split chord deployable wing UAV of claim 11, where each of said first and second wing sections is at least 3 feet in length.

14. A tube-launched missile, comprising:
a launch tube;
a missile fuselage having a longitudinal axis;
a plurality of dorsal fins positioned about the circumference of the missile fuselage and running parallel to the longitudinal axis;
a pair of deployable wings on opposite sides of the fuselage, each wing comprising first and second longitudinally extending planar wing sections stowed along the fuselage, which have abutting ends and first and second exterior longitudinal edges in a common plane, each wing section mounted for rotation in the common plane on separate pivot points adjacent said abutting ends, remaining free ends of said wing sections extending in opposite directions fore and aft from said pivot points, said first and second wing sections having complementary tongue and groove surface portions formed along the first and second exterior longitudinal edges that are progressively engaged as the first and second wing sections pivot away from said fuselage to form a single interlocked wing;
complementary gear teeth at the abutting ends of the first and second wing sections for each of the pair of deployable wings, said complementary gear teeth synchronizing movement of the first and second wing sections in the common plane; and
a deployment mechanism configured to drive the complementary gear teeth for synchronized deployment of the pair of deployable wings.

15. The tube-launched missile of claim 14, wherein the first and second longitudinally extending planar wing sections stowed along the fuselage of each of the pair of wings form at least a portion of a pair of dorsal fins.

16. The tube-launched missile of claim 15, wherein each of the dorsal fins in said pair has a fixed interior portion and an exterior portion formed by the stowed first and second wing sections.

17. The tube-launched missile of claim 14, wherein the plurality of dorsal fins comprises four dorsal fins spaced around the missile fuselage, two of the four dorsal fins are fixed and two of the dorsal fins are at least partially formed by the stowed first and second wing sections.

18. The tube-launched missile of claim 14, wherein the missile fuselage comprises a rocket motor assembly and a, guidance and warhead assembly and a split chord deployable wing assembly connected between the rocket motor and the guidance and warhead assemblies, said split chord deployable wing assembly including the pair of deployable wings and the deployment mechanism.

19. The tube-launched missile of claim 14, wherein said first and second wing sections' complementary tongue and groove surface portions are segmented so that tongue segments are nested within complementary groove segments, said tongue segments surrounded on four sides, above and below and interior and exterior, by the groove segments to interlock and form the single interlocked wing to provide both vertical stability at an interface between the first and second wing sections to loads normal to the wing and sheer stability axially along the interface.

20. A split chord deployable wing assembly for a tube-launched missile comprising a rocket motor assembly and a guidance and warhead assembly, comprising:
a cylindrical fuselage adapted for coupling between the rocket motor assembly and the guidance and warhead assembly;
a pair of deployable wings on opposite sides of the cylindrical fuselage, each wing comprising first and second longitudinally extending planar wing sections stowed fore and aft of the circular fuselage, which have abutting ends and first and second exterior longitudinal edges in a common plane, each wing section mounted for rotation in the common plane on separate pivot points adjacent said abutting ends, remaining free ends of said wing sections extending in opposite directions fore and aft from said pivot points, said first and second wing sections having complementary tongue and groove surface portions formed along the first and second exterior longitudinal edges that are progressively engaged as the first and second wing sections pivot away from said fuselage to form a single interlocked wing;
complementary gear teeth at the abutting ends of the first and second wing sections for each of the pair of deployable wings, said complementary gear teeth synchronizing movement of the first and second wing sections in the common plane; and
a deployment mechanism configured to drive the complementary gear teeth for synchronized deployment of the pair of deployable wings.

21. The split chord deployable wing assembly for tube-launched missiles of claim 20, wherein said first and second wing sections' complementary tongue and groove surface portions are segmented so that tongue segments are nested within complementary groove segments, said tongue segments surrounded on four sides, above and below and interior and exterior, by the groove segments to interlock and form the single interlocked wing to provide both vertical stability at an interface between the first and second wing sections to loads normal to the wing and sheer stability axially along the interface.
